(19) United States
(12) Patent Application Publication
(10) Pub. No.: US 2008/0252137 A1
(43) Pub. Date: Oct. 16, 2008

(54) WHEEL COVERING SYSTEM

(75) Inventors: RONALD NECAISE, KERRVILLE, TX (US); FENTON A. LIFFICK, CHINO, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: PRESTIGE AUTOTECH CORPORATION, CHINO, CA (US)

(21) Appl. No.: 12/111,855

(22) Filed: Apr. 29, 2008

Related U.S. Application Data
(63) Continuation-in-part of application No. 11/626,554, filed on Jan. 24, 2007.

(51) Int. Cl. B60B 27/00

(52) U.S. Cl. 301/108.4

(57) ABSTRACT

A wheel covering system is disclosed having a first external cover element and a second internal cover element screwed to the first element. The wheel covering system is connected to an hub of a large vehicle such as a truck without relying on lugs provided on the hub for connecting the wheel to the hub. The connection is achieved by relying on bolts used to attach a hub cap (or axle cover) to the axle, without eliminating the hub cap (or axle cover). Provision is made for adjusting the length of the connector or mounting member.

### CROSS-REFERENCES TO RELATED APPLICATIONS

This application is a continuation-in-part of U.S. application Ser. No. 11/626,554, filed Jan. 24, 2007 and incorporated herein by reference in its entirety.

### BACKGROUND OF THE INVENTION

The present application relates to ornamental wheel covers, in particular to wheel cover assemblies that are suitable for affixing to vehicles such as heavy trucks, or rigs, and the like.

The motor vehicular transport industry today is a vibrant part of the economy, and many large transport trucks and rigs are privately owned. Indeed, many a large rig is the effective home of its private owner, providing onboard computers, communication systems, televised entertainment, and sleeping quarters. Ornamentation of the exterior has become an important aspect of personal ownership. Accordingly, the fitting of ornamental wheel covers over the wheels of large rigs and trucks has become widespread in recent years.

Unfortunately, the devices and methods used to attach ornamental cover assemblies over the wheels of large vehicles suffer from various shortcomings. Commonly, some devices for attaching ornamental covers over wheels have relied upon outwardly extending threaded lugs which are typically provided on the axle for attaching the wheel to the hub. Although this method uses structure present on the vehicle which is clearly intended for affixation of structure (such as a wheel), the method has the disadvantage of making the integrity of the wheel attachment structure dependent upon the viability of a foreign structure that was not part of the vehicle manufacturer's original wheel attachment design. The addition of foreign structure to the original wheel attachment assembly may lead to shortcomings, and indeed, may lead to denial of insurance coverage where the shortcomings are attributable to structure foreign to the original vehicle design. Additional problems may arise should the vehicle be subject to inspection by local, state, or federal authorities. Some inspectors may require that ornamental wheel covers be removed to present a clear view of the wheel attachment system. Removal of the covers may require the vehicle to be jacked up, on a wheel by wheel basis, to take the load off each wheel while the covers are being removed, causing considerable inconvenience.

One method for attaching wheel covers over wheels that has been used to avoid relying on structure dedicated to wheel attachment is to launch a cover attachment assembly from a hub's oil or grease hub cap attachment structure, rather than the wheel attachment structure. One such device that has been developed provides a number of threaded rods, each rod having a stop nut toward each end. A first stop nut is set at a desired position along the length of the rod, allowing the rod to be inserted, at one end, to a desired depth into a threaded hole in the hub that would otherwise receive one of the half dozen or so bolts for holding down a hub cap. (Three such threaded rods might be provided in triangulated formation, displacing three of the regular hub cap hold-down bolts.) At the other end of each rod, a second stop nut may be adjusted to permit an ornamental wheel cover to be set to the correct orientation in relation to the wheel. In this way, any loading applied to the ornamental wheel cover is transmitted via the rods back to the grease hub, and the wheel attachment structure is left unaffected by any impact or load upon the ornamental wheel cover.

However, a shortcoming in the foregoing structure is that it is flimsy, in that an impact on the ornamental wheel cover may permanently bend or buckle the rods out of original alignment, leaving the wheel cover in a disfigured spatial relationship to the wheel, defeating the purpose of the ornamentation.

Another shortcoming found in the prior art relates to the bolts or studs used to affix the wheel cover over the wheel. Typically, an ornamental wheel cover sized to fit a large truck, and configured to survive the kind of occasional impact load that can be expected in this context, may be made of cast aluminum, and may weigh about 15 to 30 pounds. It has been found that a wheel cover having such a large weight may suffer from inadequate torsional and shear attachment to the wheel hub where insufficient attachment means are provided. Where a single central stud is provided for attachment, the rotational momentum of a heavy wheel cover may cause the cover to incline to rotate independently when the vehicle is brought to a sudden stop, because the wheel cover does not have its own braking system and may not be connected over the wheel other than at a central stud. Added to the problem of rotational momentum may be the problem of shear, which may be additionally incurred when the cover is impacted by collision with a curb, bollard or the like.

In addition to the foregoing, problems may arise in providing a solution to the foregoing in that different truck types have different dimensions around the wheel and axle area. Thus, it is desirable to provide a suitable attachment system for a wheel cover that may be used with a number of differently configured vehicles.

Accordingly, there is a need for an improved structure and method of affixing ornamental wheel covers over wheels of vehicles such as trucks. The present invention addresses these and other needs.

### SUMMARY OF THE INVENTION

According to a preferred embodiment of the invention, there is described a wheel covering system that provides a sturdy and robust system for attaching an ornamental wheel cover over a wheel of a large vehicle such as a truck or rig, coverable of withstanding the kind of impact load that a wheel cover might experience over its lifetime, yet being easy to attach, and avoiding connection with the wheel attachment system of the axle hub.

In a preferred embodiment, the wheel covering system is configured for attachment to a vehicle hub in which the hub has a plurality of threaded lugs for attaching a wheel, and on which a hub cap is attached to the hub by a plurality of threaded bolts. The system includes an ornamental cover having a center point and is configured to be positioned adjacent the wheel, the cover having two holes, each hole offset an equal distance from the center point. A mounting member is provided for connecting the cover over the wheel. The mounting member is configured to be removably attached to two diametrically opposite sides of the hub cap without being in contact with the threaded lugs. The mounting member has a distal end and a proximal end, in which the distal end defines a plurality of holes configured to receive at least some of the threaded bolts that hold down the hub cap. (The terms “distal” and “proximal” as referred to herein are from the perspective of one installing the covering system, thus meaning inward and outward of the vehicle respectively.) These holes are for permitting both the mounting member and the hub cap to be attached to the hub, the mounting member spanning across the outside of the hub cap. The proximal end of the mounting member includes two outwardly extending threaded studs for insertion into the two holes of the ornamental cover, to permit removable attachment of the cover to the mounting member. Thus, the invention avoids any connection to the threaded lugs which are used for attaching the wheel to the hub.

In a further aspect, the wheel covering system includes a feature in which the ornamental cover has a third hole at the center point, and the proximal end of the mounting member includes a spindle positioned to be inserted through the third hole. Preferably, the spindle may be longer than the flanking studs. Thus, the spindle advantageously facilitates attachment of the cover over the wheel because, when the mounting member has been attached to the hub, it permits the operator to slip the cover over the spindle first, then, by rotating the cover somewhat, to match the two offset holes in the cover with the studs and push the cover over the spindle and studs. The central hole may have a conical portion to facilitate this action. The studs and spindle provide a high degree of redundancy to secure the connection and provide a factor of safety against rotational and shear forces that may be exerted during braking or in a collision.

In other aspects of the covering system, the ornamental cover has a recess for housing the studs. A bolt-on cap closes off the recess, providing a smooth outer surface to the cover when completely mounted. Preferably, the recess has a floor that is flat, and the proximal end of the mounting member is flat. Thus, the floor of the recess is configured to be compressed against the proximal end of the mounting member by nuts screwed onto the threaded studs, and this provides a secure and wobble free attachment of the cover to the mounting member.

In one embodiment of the invention, principally for steering and trailing axles, the mounting member includes a cylindrical portion, an external flange attached to the distal end of the mounting member, and a circular plate attached to the proximal end of the mounting member. Preferably, the cylindrical portion is between 3 and 4 mm thick, to provide a sufficiently light but robust mounting member for connecting the cover to hub. A plurality of holes are formed in the flange to receive the hub cap bolts, whereby both the mounting member and the hub cap may be attached to the hub, the mounting member covering the hub cap. The threaded studs are attached to the circular plate at the proximal end of the mounting member. Preferably, the mounting member includes a slot configured to receive a valve of the hub cap. In this way, the oil or grease level may be maintained without removing the mounting member from the hub. Additionally, the mounting member may include an orifice positioned to allow inspection, through the mounting member, of the oil or grease level in the hub cap. Thus, the oil or grease level may be checked without removing the mounting member from the hub.

In a second embodiment, principally for drive axles, the mounting member is configured to provide attachment of an ornamental cover to a hub having an axle mounting cap. The mounting member of this embodiment also does not contact threaded lugs on the hub that are intended for attaching a wheel to the axle. However, here, the mounting member is formed from an initially flat plate having two ends. The plate is bent to a configuration adapted to span across the axle mounting cap and to be fixed to the axle mounting cap at the two ends. In this embodiment, the thickness of the plate is preferably between 4 mm and 5 mm to provide desirable stiffness and strength. This configuration also overcomes shortcomings in the prior art, and provides a sufficiently robust configuration for a wheel covering system that can be expected to experience impact loads during its lifetime.

In yet a further embodiment of the invention, a wheel covering system for attachment to a vehicle axle is described, in which the axle has a plurality of threaded lugs for attaching a wheel, and in which a hub cap is attached to the axle by a plurality of threaded bolts. This embodiment comprises an ornamental cover having a center point and configured to be positioned adjacent the wheel, the ornamental cover having two holes, each hole offset a given distance from the center point. The embodiment includes a mounting member configured to be removably attached to two diametrically opposite sides of the hub cap without being in contact with the threaded lugs. The mounting member has a distal end and a proximal end, and the distal end defines a plurality of holes configured to receive at least some of the threaded bolts for attaching both the mounting member and the hub cap to the axle. Moreover, the proximal end includes two outwardly extending threaded studs for insertion into the two holes so as to removably attach the cover to the mounting member. In this embodiment, the mounting member has an axis and includes a proximal portion and a distal portion, in which the proximal portion includes a first cylindrical portion and the distal portion includes a second cylindrical portion, the first cylindrical portion being sized to slide telescopically in relation to the second cylindrical portion, and the proximal portion and distal portion have at least one corresponding threaded and unthreaded hole combination for receiving a screw to prevent the proximal portion moving in relation to the distal portion. This feature permits the length of the mounting member to be adjusted to suit a variety of vehicles on the market, and allows a dealer to stock fewer mounting members to supply a market.

In yet a further aspect, the invention describes a wheel covering system for attachment to a vehicle axle, in which the axle has a plurality of threaded lugs for attaching a wheel, and in which a hub cap is attached to the axle by a plurality of threaded bolts. The system comprises an ornamental cover configured to be positioned adjacent the wheel, and a mounting member configured to be removably attached to the hub cap without being in contact with the threaded lugs, the mounting member having a distal end and a proximal end, wherein the distal end defines a plurality of holes configured to receive at least some of the threaded bolts for attaching both the mounting member and the hub cap to the axle, and further wherein the proximal end is configured to attach the ornamental cover to the mounting member. The plurality of holes defined by the distal end of the mounting member are characterized in that the holes lie on a circumferential plane and include ten holes, the second, fourth, sixth, eight and tenth holes being spaced from the first hole at increments of 60 degree arcs, and the third, fifth, seventh, and ninth holes being spaced from the first hole at increments of 72 degree arcs.

In yet a further aspect of the invention, there is described a wheel covering system for attachment to a vehicle axle, in which the axle has a plurality of threaded lugs for attaching a wheel, and in which a hub cap is attached to the axle by a plurality of threaded bolts. This embodiment comprises a first cover element configured to be positioned adjacent the wheel, a second cover element attached to the first cover element along an outer circumferential line by a plurality of screws, and a mounting member configured to be removably attached to the hub cap without being in contact with the threaded lugs, the mounting member having a distal end and a proximal end, wherein the distal end defines a plurality of holes configured to receive at least some of the threaded bolts for attaching both the mounting member and the hub cap to the axle, and further wherein the proximal end is configured to attach the first cover element to the mounting member. The second cover element includes a plurality of elongate openings, and a rigid flap positioned adjacent each opening. Each flap extends outwardly from a surface of the second cover element, and each alternate flap is positioned on a circumferentially opposite side of an opening compared with the position of each adjacent flap. This configuration improves air flow in the vicinity of the braking system of the vehicle.

These and other advantages of the invention will become more apparent from the following detailed description thereof and the accompanying exemplary drawings.

### BRIEF DESCRIPTION OF THE DRAWINGS

FIG. 1 is a perspective view of a typical wheel attached to an hub of a truck.

FIG. 2 is a vertical sectional view of a mounting member used in the present invention.

FIG. 3 is a plan view of the mounting member of FIG. 2.

FIG. 4 is the wheel of FIG. 1, including the mounting member of FIGS. 2 and 3.

FIG. 5 is a vertical sectional view of the wheel in FIG. 4, including a wheel covering system having features of the present invention.

FIG. 5A is an expanded view of the central portion of FIG. 5.

FIG. 6 is a perspective view of a typical drive wheel attached to a different kind of hub of a truck.

FIG. 7 is a vertical sectional view of an embodiment of a mounting member suitable for use with the wheel and hub of FIG. 6.

FIG. 8 is a plan view of the mounting member of FIG. 7.

FIG. 9 is the wheel of FIG. 6, including the mounting member of FIGS. 7 and 8.

FIG. 10 is a vertical sectional view of the wheel in FIG. 9, including a wheel covering system attached.

FIG. 10A is an expanded view of the central portion of FIG. 10.

FIG. 11 is an elevational view of a further embodiment of the mounting member shown in FIGS. 2 and 3, shown in a first joined configuration

FIG. 12 is an elevational view of the mounting member shown in FIG. 11, shown in a separated configuration.

FIG. 13 is a plan view of the mounting member shown in FIG. 1.

FIG. 14 is a sectional view of the mounting member of FIG. 12, taken substantially through the line 14-14 in FIG. 12

FIG. 15 is a detail view of an aspect of the present invention.

FIG. 16 is an front elevational view of a component of the present invention.

FIG. 17 is a side elevational view of the component of FIG. 16.

FIG. 18 is a sectional view taken substantially along the line 18-18 in FIG. 16.

### DETAILED DESCRIPTION OF THE PREFERRED EMBODIMENTS

With reference to the drawings which are by way of example and not limitation, a wheel cover assembly and attachment system is disclosed having features of the wheel covering system of the present invention. In setting forth the features of the present invention, there will first be described a cover assembly of a preferred embodiment that is structured for incorporation with the wheel covering system of the present invention. Second, there will be described one kind of heavy truck hub structure that a wheel cover assembly will commonly encounter for attachment. Third, there will be described one preferred embodiment of an attachment system structured for incorporation with the wheel covering assembly of the present invention in the context of the described truck hub. Fourth, there will be described a further type of heavy truck hub structure that a wheel cover assembly may commonly encounter for attachment. Fifth, there will be described variations to the embodiments of the wheel cover assembly and attachment systems earlier described.

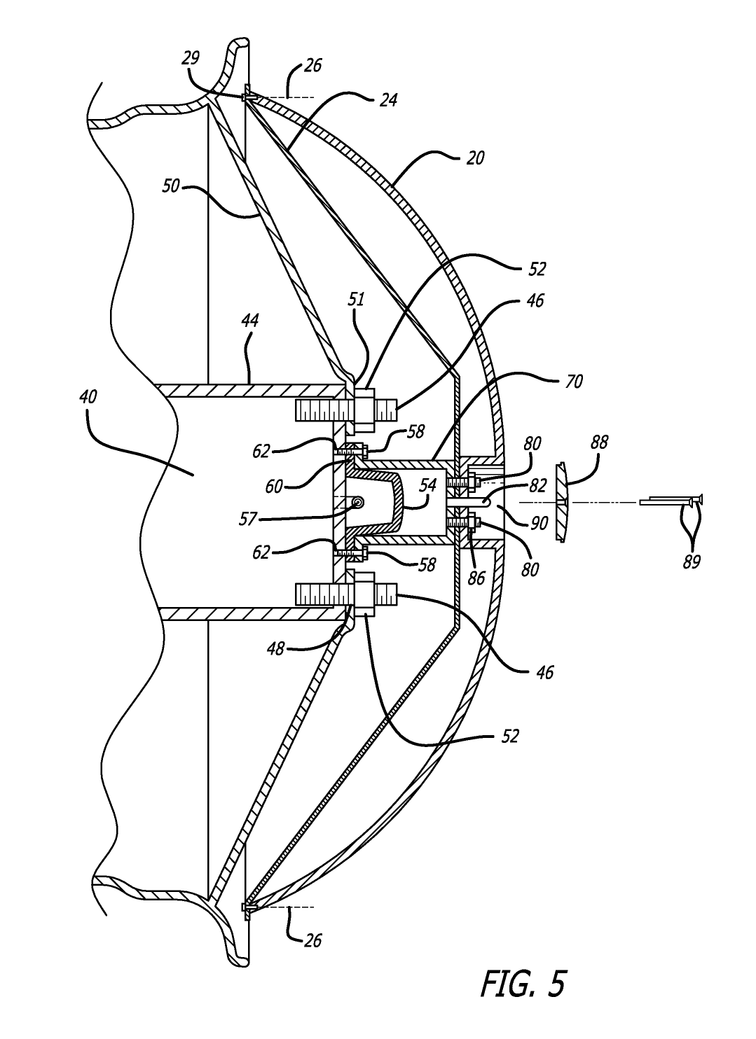

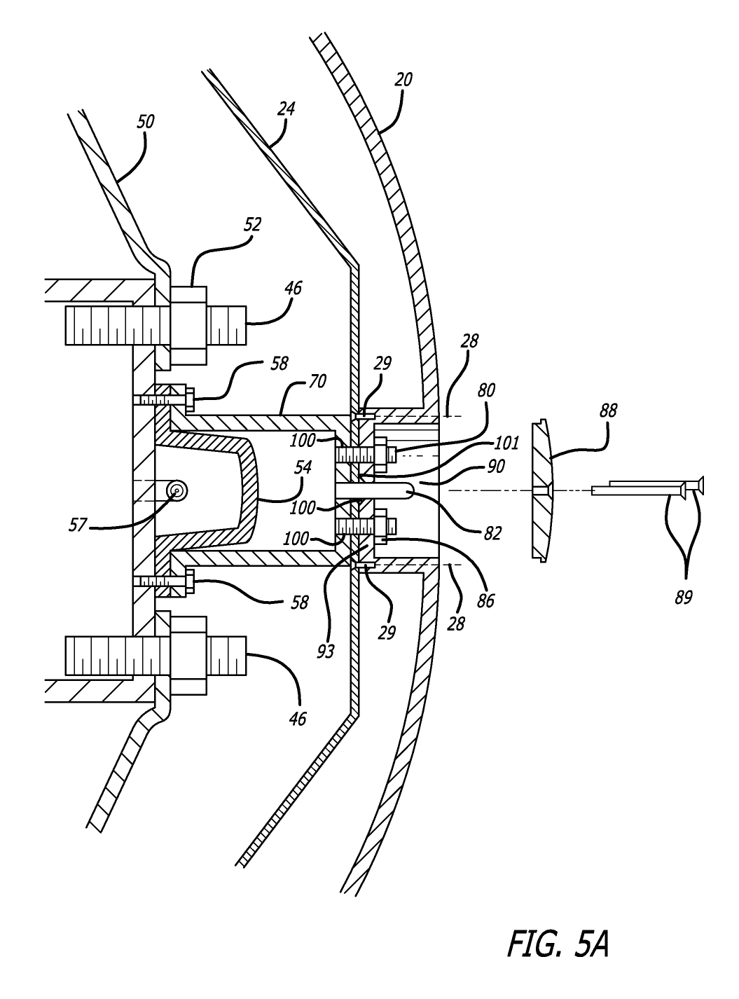

Turning now to a first embodiment of a wheel cover assembly of the present invention, as best seen in FIG. 5, an ornamental outer cover adapted for attachment according to the present invention is generally indicated by the numeral 20. Where the cover 20 is intended for attachment to a large vehicle such as a truck or rig, it is beneficially made of cast aluminum, and may weigh as much as about 15 to 30 pounds. This substantial weight gives the cover 20 considerable durability, able to withstand the occasional impact that is inevitable over the lifetime of a cover.

In a preferred embodiment, the cover 20 has openings (not shown in the figures) that give the cover a visible depth to one viewing the cover attached to a wheel. To enhance this visible depth, a second cover element is provided, being a foil sheet 24 specially made to have enhanced reflective properties on one side, preferably out of aluminum or stainless steel and in the range of 0.5 to 1 mm thick. The foil sheet 24 is placed distal to the outer cover 20 with the reflective side facing the exterior. In this way, one viewing the cover 20 looks through the openings in the cover 20 onto the reflective foil sheet 24 with the effect that the foil obstructs the view onto the unattractive structural details of the wheel attachment system, and reflects light to give an overall attractive ornamental appearance. The combination of cover 20 and foil 24 is referred to as a cover assembly, in this and in further embodiments.

In a preferred embodiment, an outer circumferential rim of the inner foil 24 may be configured to contact the ornamental cover 20 along an outer circumferential line 26 (FIG. 5), and also along an inner circumferential line 28 (seen in FIG. 5A). Matching holes may be drilled into the foil 24 and cover 20 along both the inner and outer lines of contact 26, 28 at points spaced apart, so that tapping screws 29 may be inserted through the foil 24 and screwed into the cover 20, to fixedly attach the foil 24 to the cover 20 along two circumferential lines. This attachment of foil to cover has the advantage of making the wheel assembly easy to manipulate as a single object, facilitating installation, removal, storage, and transport.

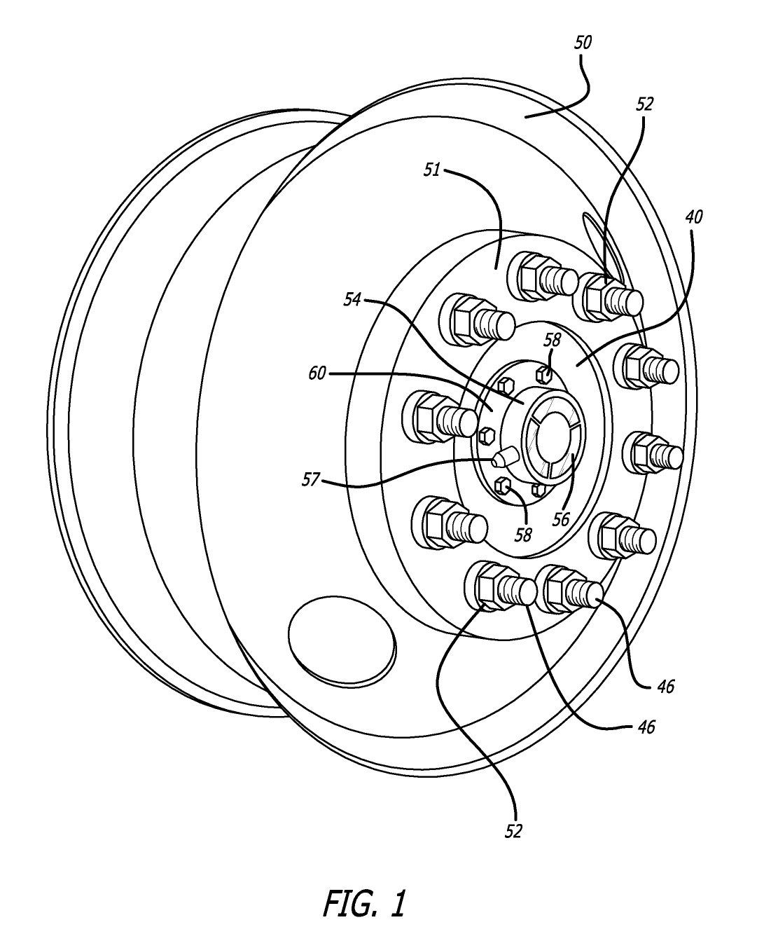

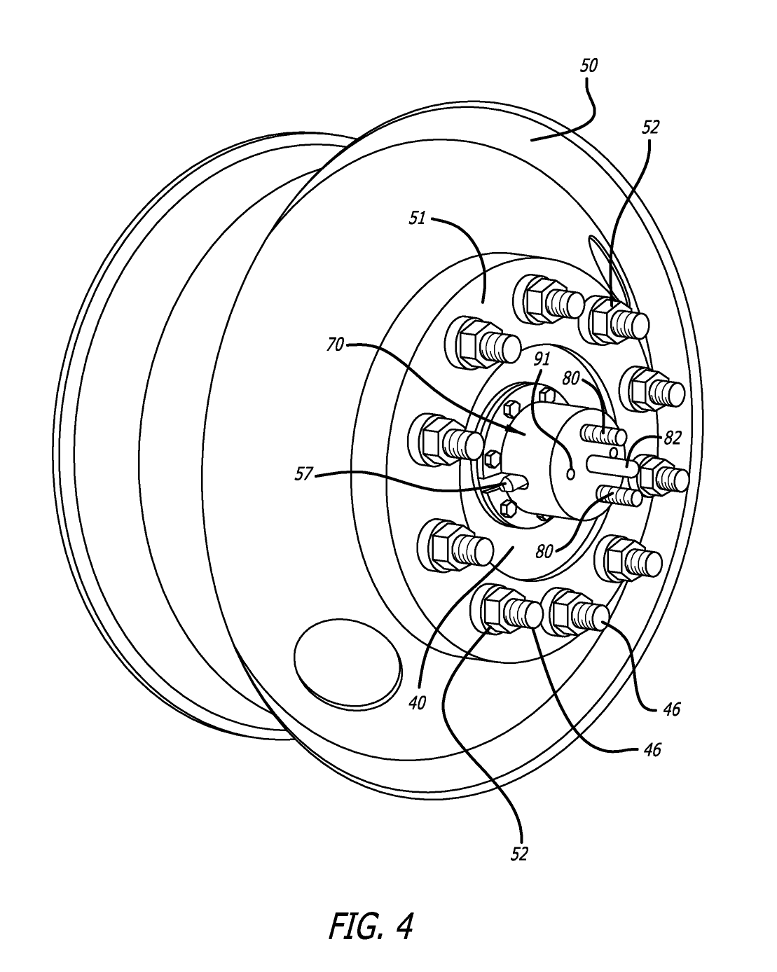

Prior to turning to the structure for connecting the cover assembly to the vehicle wheel, there will be described with reference to FIGS. 1, 4, and 5 certain features commonly found on large trucks that may provide the foundation for a device and method of connection of the present wheel covering system. Typically, the front axle 40 of a truck is the steering axle, and its terminal end commonly includes a number of features. An outer cylinder 44 acts as a hub and includes a number of lug bolts 46 (FIGS. 1, 4, and 5) protruding outwardly to be inserted through receiving holes 48 in the wheel 50 and to be covered by hex-head nuts 52 that will be tightened to a specified torque for proper operation and safety of the wheel in motion.

For the steering axle, there are commonly found three types of axle caps, (1) oil, (2) grease, and (3) non-serviceable. One of such axle caps 54 (also referred to as hub caps) of a kind typically found on a steering axle is commonly attached to the proximal end of the outer cylinder 44. The outer cylinder and hub cap rotate with the axle 40. This oil or grease hub cap will typically have a transparent window 56 (FIG. 1) to enable a vehicle operator to inspect the oil or grease level, and an oil valve 57 for introducing oil into the oil hub cap. The axle cap 54 is fixed to the axle 40 by a plurality of hub cap bolts 58 inserted through an external flange 60 on the hub cap, and into threaded hub cap holes 62 in the axle.

Turning now to a mounting member and mechanism configured to match and attach the cover assembly in the present invention, it has been determined that affixing the mounting member directly from the exterior of the axle cap 54 rather than from the lugs 46 of the outer cylinder 44 may be effectively achieved, as will be described, to produce a robust and effective connection capable of safely holding a heavy cover assembly of about 40 pounds under acceleration, deceleration, and impact loads, and that overcome shortcomings in the art.

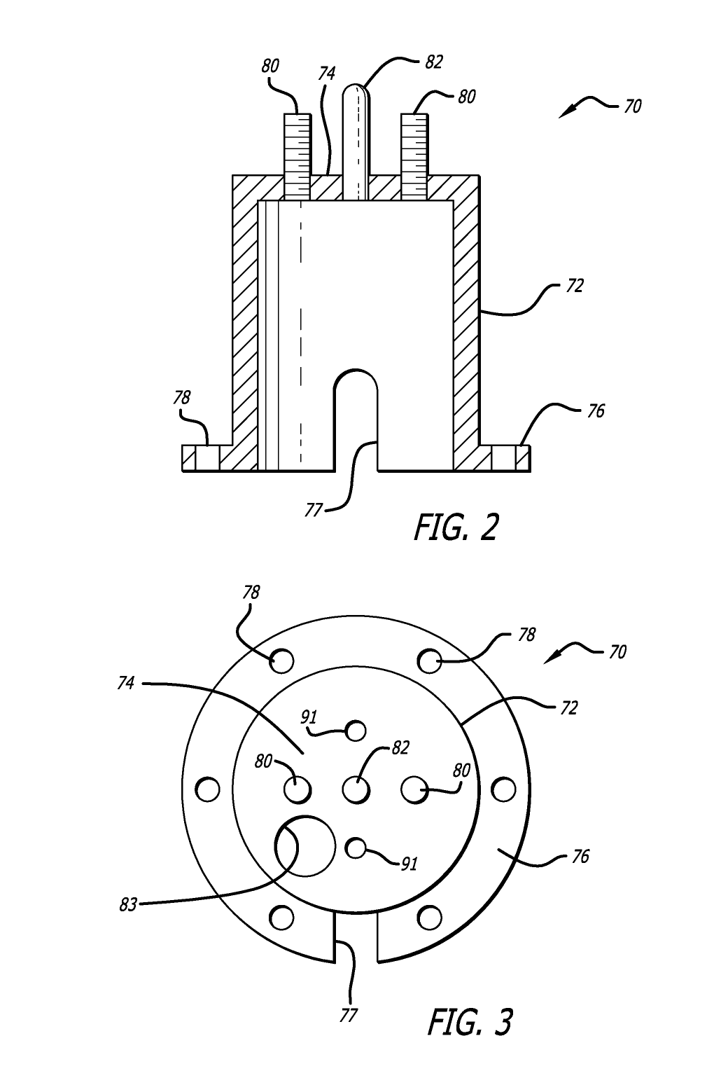

In a preferred embodiment, and as best seen in FIGS. 2 and 3, a mounting member 70 or connector is provided for operation as a structural connection between the hub 44 and the cover assembly 20, 24 for operation of the wheel covering assembly of the present invention. The mounting member 70 includes a cylindrical portion 72 that, in a preferred embodiment, is fabricated to include a spun or cast steel cylinder which, in a preferred embodiment is 3-4 mm thick. A capping portion 74 takes the form of a flat steel disc that may be welded to the proximal edge of the cylindrical portion 72. An external flange 76 is made as a flat steel annulus that may be welded to the distal edge of the cylindrical portion 72. Holes 78 are drilled into the flange 76 to correspond with the locations of the bolts 58 holding the hub cap 54 to the axle 40. When the mounting member 70 is attached to a steering hub according the present invention, the bolts 58 are removed from the hub cap 54, the mounting member 70 is positioned to straddle the hub cap 54, and the bolts 58 are replaced to attach both the hub cap 54 and the mounting member 70 to the hub 44, as exemplified in FIG. 5, thus capturing the mounting member 70 on top of the hub cap 54. (If required, a new set of bolts slightly longer than those removed from the hub cap may be used.) A slot 77 may be machined in the mounting member 70 to penetrate both the flange 76 and the cylindrical portion 72, as best seen in FIGS. 2 and 3, the slot being sized to receive the oil hub cap valve 57 which, when the mounting member is attached, may protrude outwardly from under the mounting member 70 so as to remain available to receive oil for refilling the oil cap.

On the covering portion 74 of the mounting member, two threaded lugs 80 are fixed to receive corresponding holes 100 (best seen in FIG. 5A) in the cover 20. The two threaded lugs 80 are preferably spaced equidistant from the center of the covering portion 74, diametrically opposite one another. Moreover, on the center of the covering portion 74 a threadless guide spindle 82 may be fixed, preferably having a length that is about half an inch longer than the flanking threaded lugs 80 and having a diameter that is about the same as the lugs, preferably 10-14 mm. The cover 20 has three mating holes 100 to receive the spindle first, and then the flanking lugs. Covering nuts 86 are screwed down onto the lugs 80 to secure the cover assembly onto the mounting member 70. Preferably, the covering nuts 86 are configured to have a unique circumferential profile so that the manufacturer may provide a mating socket for use by a vehicle owner. Such unique profile and mating socket, in effect, provides a key to the owner, making it extremely difficult for miscreants to remove the cover assembly without permission. A closing cap 88 may be inserted into a recess 90 in the cover 20 to protect and conceal the spindle, lugs, the covering nuts, and related assembly. The closing cap 88 may be held in the recess 90 by two bolts 89 configured to pass through the cover 20 and mate with two threaded holes 91 (FIG. 2) in the covering portion 74 for securing the closing cap 88 flush with the external surface of the cover 20. In a preferred embodiment, the floor 91 of the recess 90 is flat, thus allowing a stable and wobble free connection to be formed between the cover 20 and the mounting member 70 when the covering nuts are tightened to compress the floor against the mounting member.

Thus, under a preferred embodiment, the mounting member 70 includes two threaded lugs 80 and an additional spindle 82 for attaching the cover assembly to the hub. In light of the considerable weight of the cover assembly, two lugs and corresponding nuts provide a degree of redundancy and safety in case one of the nuts should come loose. Furthermore, by providing two lugs offset from the center, the capacity to withstand the rotational momentum applied by the cover assembly is greatly increased. It will be appreciated that the weight of the cover assembly, perhaps in the vicinity of 40 pounds, is much greater than in the case of a regular passenger automobile, and thus unbalanced angular momentum of the cover assembly caused by sudden braking may be substantial. The provision of a redundant second lug and nut combination, offset from the center of the cover, is advantageous in dealing with such momentum.

Moreover, in addition to the rotational forces exerted by the cover assembly, an additional force may be exerted as a shear force when the cover 20 is subject to an impact such as may be applied when hitting a curb, bollard, or other object, a not uncommon experience in the lifetime of a wheel cover. The ability of the wheel covering system to withstand these forces is greatly enhanced by the addition of the central spindle 82, so that three separate protrusions (the two lugs 80 and the spindle 82) are provided to withstand shear forces caused by impact.

An additional advantage provided by the central spindle 82 in combination with two lugs 80 is firstly that the spindle provides a guide pin to facilitate installing the cover assembly. A feature of the cover 20 provided to facilitate installation on the hub is that the central hole 100 on the cover 20 may be configured to terminate, on the inside face, in a conical taper 101 (FIG. 5A). Thus, because the spindle 82 is about half an inch longer than the flanking lugs 80, the installer is able to locate the central spindle 82 in the central hole 100 by sliding the cover past the spindle. When the spindle falls into the cone 101, the installer knows that he has found the correct hole, and pushes the cover assembly inwards so that its significant weight is taken by the spindle 82. Then, by rotating the cover assembly somewhat, the installer may easily align the lugs 80 with their corresponding holes 100, and push the cover assembly onto the lugs 80 before installing and tightening the covering nuts 86. The longer spindle feature eliminates the difficulty of having to simultaneously manually support the full weight of the cover assembly and find the correct cover alignment with respect to the two lugs 80 before the cover assembly may be pressed over the lugs.

In a further aspect, the mounting member 70 may include an aperture 83 cut into the proximal end of the mounting member (seen in FIG. 3), to enable the vehicle operator to view the oil or grease level in the hub via the window 56 in the oil or grease hub cap 54. The aperture 83 must be at the topmost point of its rotational travel for the vehicle operator to correctly assess the adequacy of the grease level. Thus, if the aperture is not at the topmost point of its travel when the vehicle is at rest, it may be necessary to roll the vehicle forward somewhat to bring the aperture 83 up to the topmost point of its travel before an inspection can be conducted.

It will be appreciated that the structure described has the further advantage of allowing a vehicle operator to remove a wheel by removing only the cover assembly. The mounting attachment 70 may remain in place on the hub while the wheel is removed, thereby avoiding the inconvenience of having to remove structure in addition to the wheel when changing or repairing a wheel.

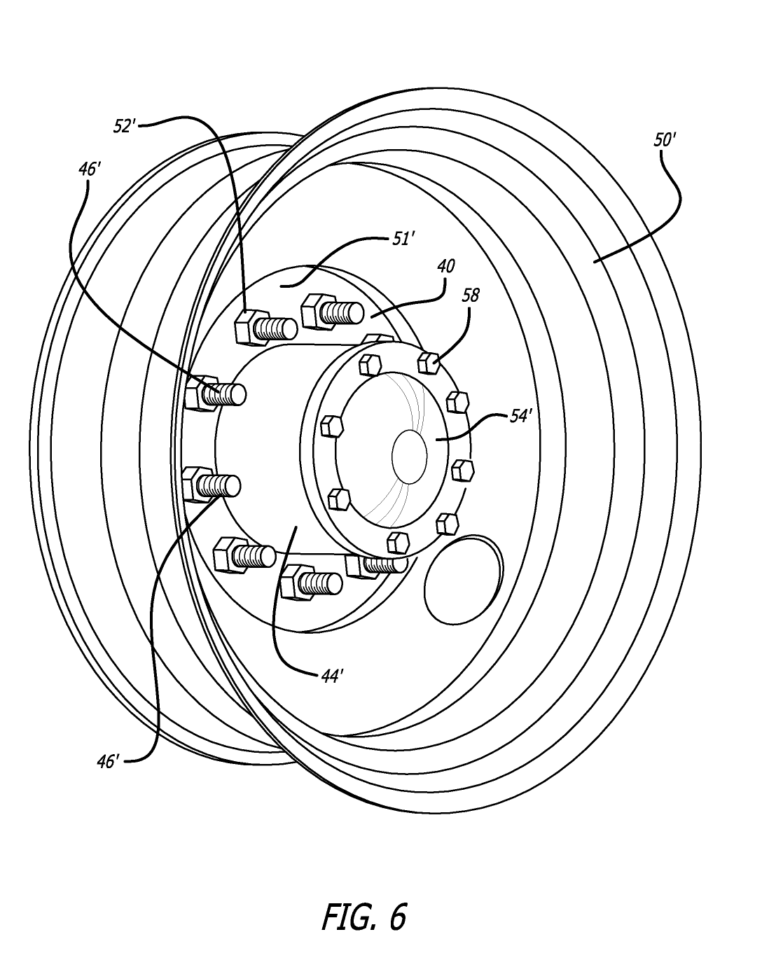

Turning now to another embodiment of the present invention there is now described with reference to FIGS. 6-10 a wheel covering system having alternative features of the present invention. It is a common aspect of large trucks or rigs that they may have three (or more) sets of axles. The front axle is generally the steering axle, commonly having features such as those described above. Behind the front axle is a typically a drive axle, followed by a trailing axle. One variation between a steering axle and a drive axle is that a drive axle may have two wheels on each side, in which the geometry of the outer driving wheel differs from the geometry of the single steering wheel. Whereas a steering wheel is commonly configured to present a radially inner disc portion 51 generally flush with the outside profile of the wheel 50, as exemplified in FIGS. 1, 4, 5, an outer driving wheel is commonly configured to present a radially inner disc portion 51′ generally flush with the inside profile of the wheel 50′ as exemplified in FIGS. 6, 9, 10. Additionally, the outer drive axle commonly does not have a large oil or grease inspection cover (as a steering wheel may have), but rather may have a flat or bulbous plate sealing the hub, as exemplified in FIG. 6. In light of these variations of the geometry of the various hub to wheel configurations typical in a large vehicle, a further embodiment of the present invention is described.

Turning to FIGS. 6-10, there is described an alternative attachment system for attaching an ornamental wheel cover to a drive axle of a large truck. Where numerals are shown to be “primed,” they refer to the same element as in the former embodiment, with any modifications made to suit the present embodiment. As in the case of the embodiment of the steering wheel covering system exemplified in FIGS. 1-5, the drive wheel covering system of the present embodiment includes an ornamental cover 20′ which may similarly have openings (not shown in the figures), a foil 24′ shaped to fill in a larger void in the wheel distal to the cover 20′ and having a reflective surface facing the exterior of the cover to create visible depth in the cover. As in the former embodiment, the foil may be screwed onto the cover by screws 29′ tapping into the cover 20′ along two circumferential lines 26′, 28′ (outer and inner), thus forming a single cover assembly that can be readily manipulated into place over the wheel, stored, and transported.

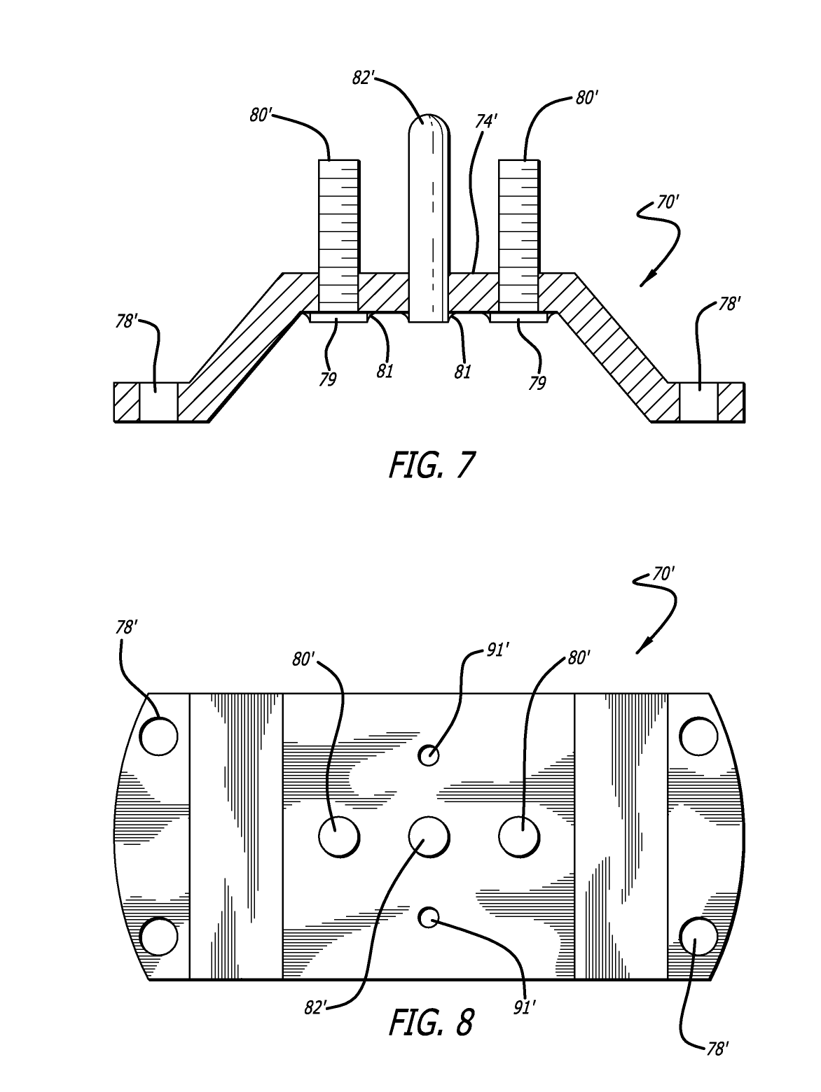

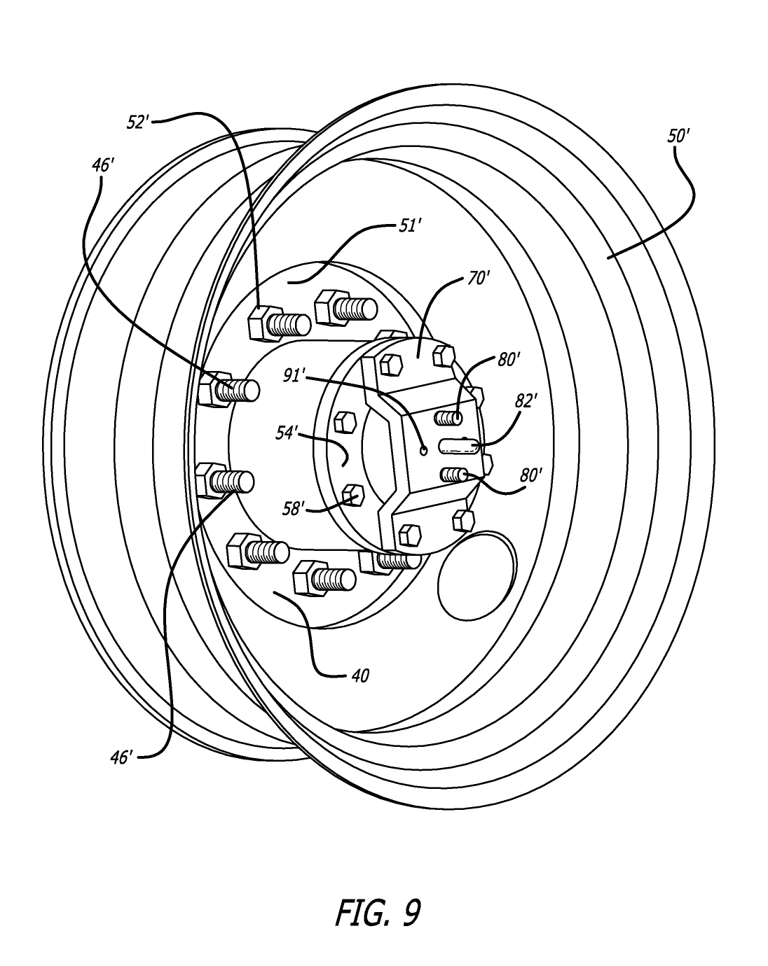

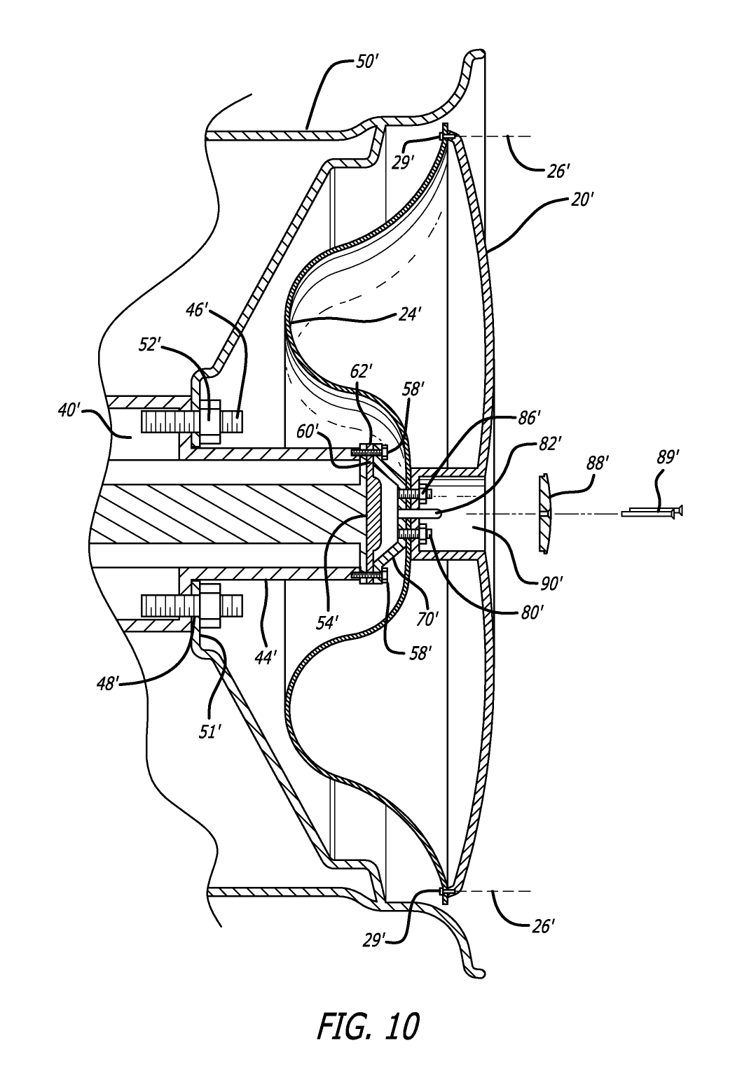

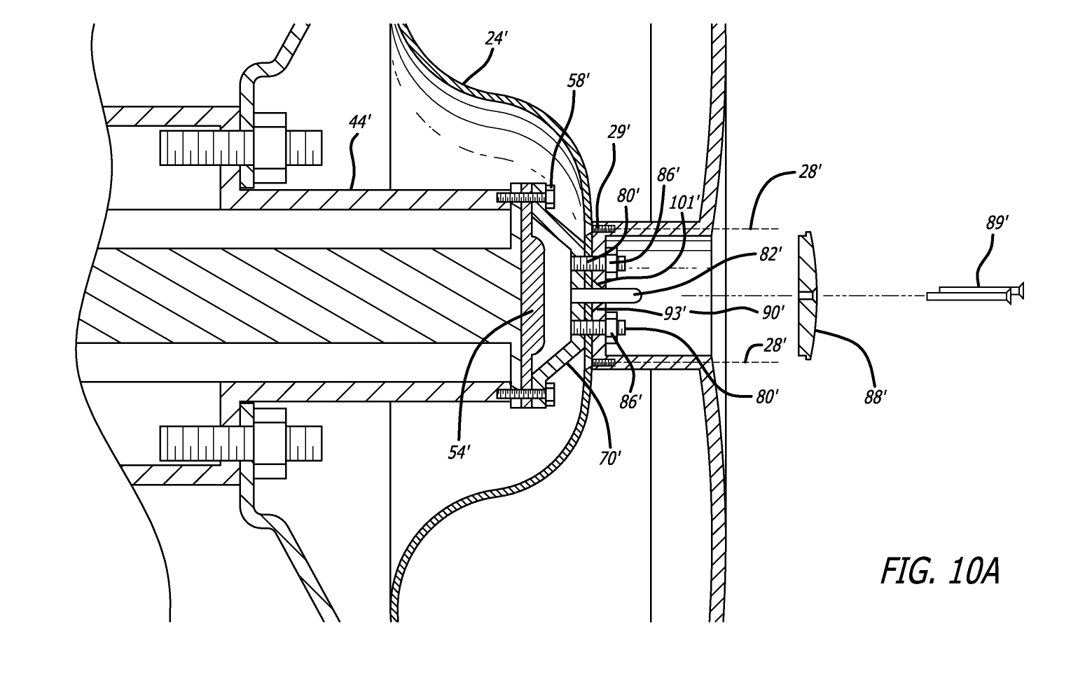

The mounting member 70′ in this second embodiment is exemplified best in FIGS. 7-8. The mounting member is not formed from a cylinder as in the previous embodiment, but in this case may be fabricated from a flat metal plate which is then bent to a shape suitable for spanning over a bulbous axle cap 54′ covering the driving wheel hub 44′, as exemplified in FIGS. 7-8, and 10. Preferably, as in the previous embodiment, the proximal surface 74′ of the mounting member is flat, and vertical, when in use. In a preferred embodiment, the thickness of the flat metal plate is between 5 and 6 mm, to provide suitable stiffness and strength without excessive weight. The extremities of the plate may be shaped to conform to the circular perimeter of the hub 44′. Holes 78′ are provided in the extremities of the plate and positioned to match locations of the axle cover bolts 58′ holding down the bulbous axle cap 54′ on the hub. The mounting member 70′ of this embodiment similarly includes two threaded lugs 80′ positioned at a proximal end, offset from the center of the mounting member, and a threadless spindle 82′ at the center, as in the previous embodiment, for installation of the cover assembly of the present embodiment in a similar way. Preferably, the lugs 80′ in this embodiment are threaded hex-head bolts threadingly inserted through mating threads in the mounting member 70′, the hex-heads 79 being positioned on an inner surface of the mounting member to provide enhanced reinforcement against any pullout force applied to the lug 80′ in an impact situation, as best seen in FIG. 7. Further preferably, the hex heads 79 are butt welded 81 to the inner surface of the mounting member to provide yet further added reinforcement to any pullout force that might be applied to the lugs 80′. Because of space limitations under the mounting member, it is desirable to machine off a portion of the hex-heads 79 on the lugs to create room for the hub cape 54′. It has been found that the bent plate mounting member 70′ embodiment, although not as stiff as the cylindrical mounting member 70 of the previous embodiment, provides an inexpensive yet adequate and robust solution to connecting an ornamental wheel cover over a drive wheel of a truck and overcomes shortcomings in the prior art without adding excessive weight. As in the previous embodiment, the cover assembly includes a closing cap 88′, held in position by two threaded bolts 89′ configured to pass through the cover 20′ and mate with two threaded holes 91′ in the mounting member 70′. FIG. 10. Finally, as in the previous embodiment, the floor 93′ of the recess is flat, to permit the cover 20′ to form a stable and wobble free connection to the mounting member 70′ when the covering nuts 86′ are tightened.

Thus, when the wheel covering system of the present embodiment is to be installed, the installer removes the corresponding bolts 58′ from the hub 44′, places the mounting member 70′ over the axle cap 54′, and reinserts the bolts 58′ in the same threaded holes from which they have been removed, thereby capturing the mounting member 70′ on top of the axle cap 54′. (If required, longer bolts may replace the original bolts.) The mounting member 70′ presents a suitable connection so that the covering system is mounted over the wheel on a part of the vehicle hub that is independent of the wheel attachment system. The mounting member 70′ has adequate stiffness and strength to resist the magnitude of loads that will be applied to the wheel cover during its lifetime, and overcomes shortcomings in the prior art. The mounting member and related cover assembly may be easily removed from the hub without having to jack up the wheel, and it is configured to resist unbalanced forces that may be caused by sudden stopping and impact loads.

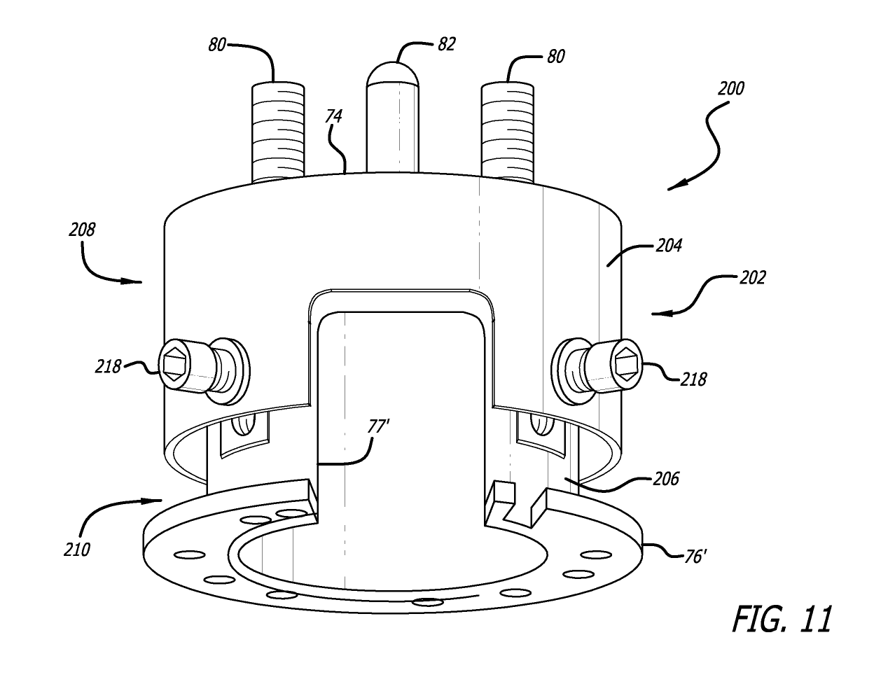

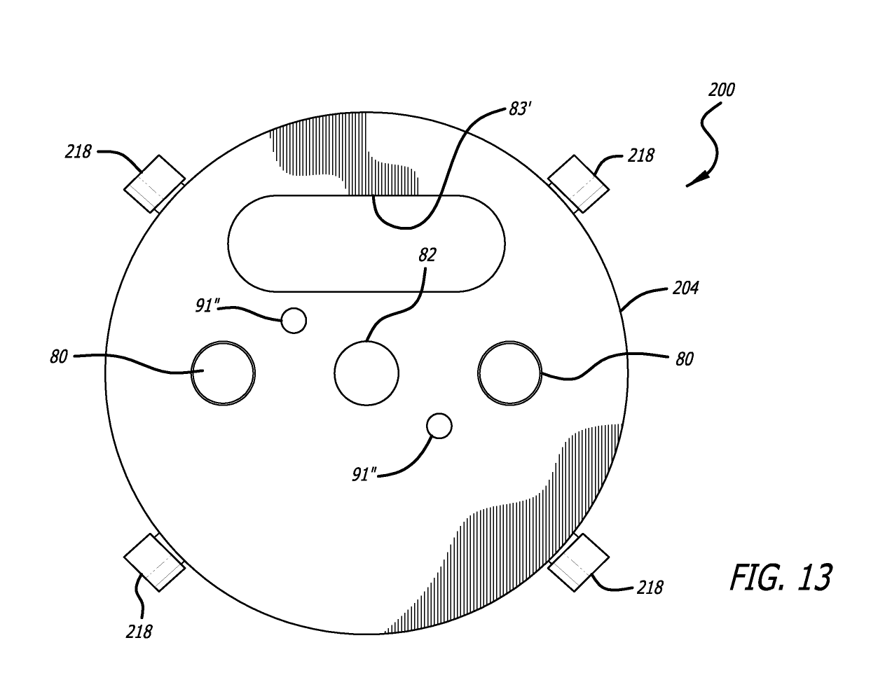

Turning now to a variation on the above described invention, a mounting member 200 is described with reference to FIGS. 11-15. The embodiment of this variation is directed to providing a mounting member that can be varied in its axial length, and which may be affixed to more than one type of axle. For example, in some trucks the end of an axle may be positioned distally extending by a greater amount than in others. Furthermore, some truck axles have five hub cap holes 62 and some have six. The embodiment here disclosed has the advantage of allowing stockists of the various components of the present invention to reduce the amount of stock they carry. Rather than carrying a large number of differently configured components for each of the many different makes of truck that are on the market today, a stockist may, by using the present invention, carry a few components that are compatible with many of the trucks on the market.

The first variation made to the previously described embodiment to achieve this objective is to provide a mounting member 200 having a cylindrical portion 202 comprising two cylindrical sleeves 204, 206, one of which has a larger diameter than the other and which is configured to slide over the other sleeve to produce a telescoping relationship between the two sleeves. Thus, the mounting member 200 is divided into a proximal portion 208 and a distal portion 210. In a preferred embodiment, the proximal portion telescopes over the distal portion, although the converse is also feasible. The proximal portion carries the capping portion 74 with the lugs 80 and spindle 82, and the distal portion carries the flange 76′. These are elements previously described above. In the present embodiment, the flange is generally designated 76′ to indicate that changes are made to the previously described embodiment.

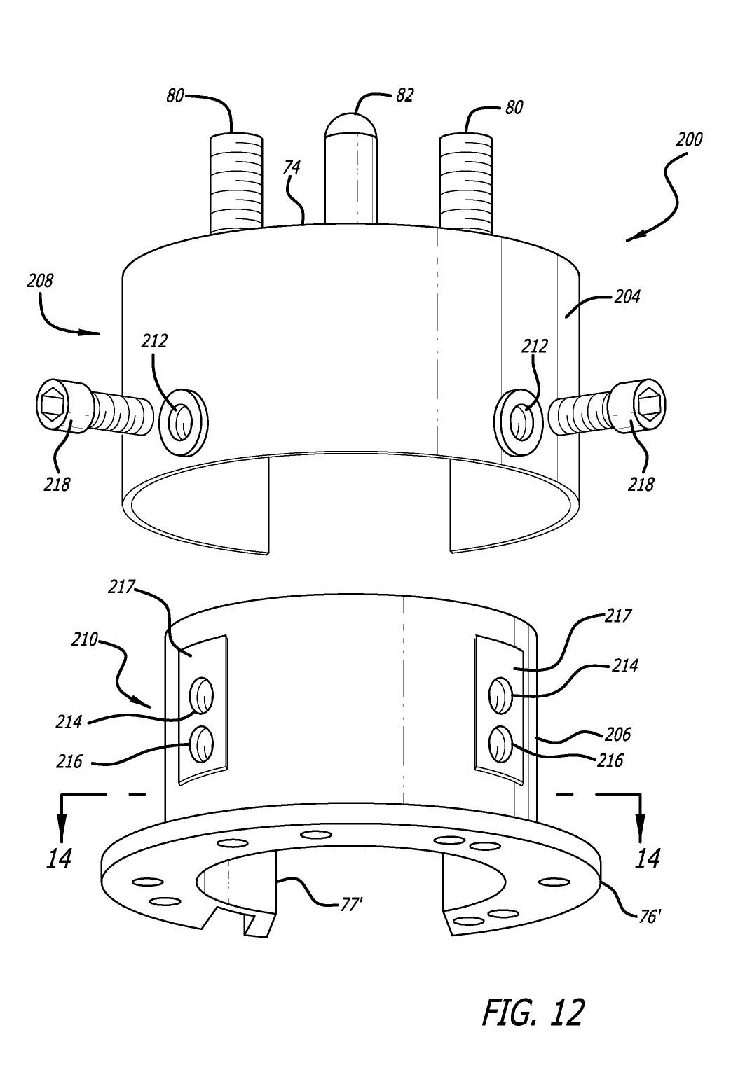

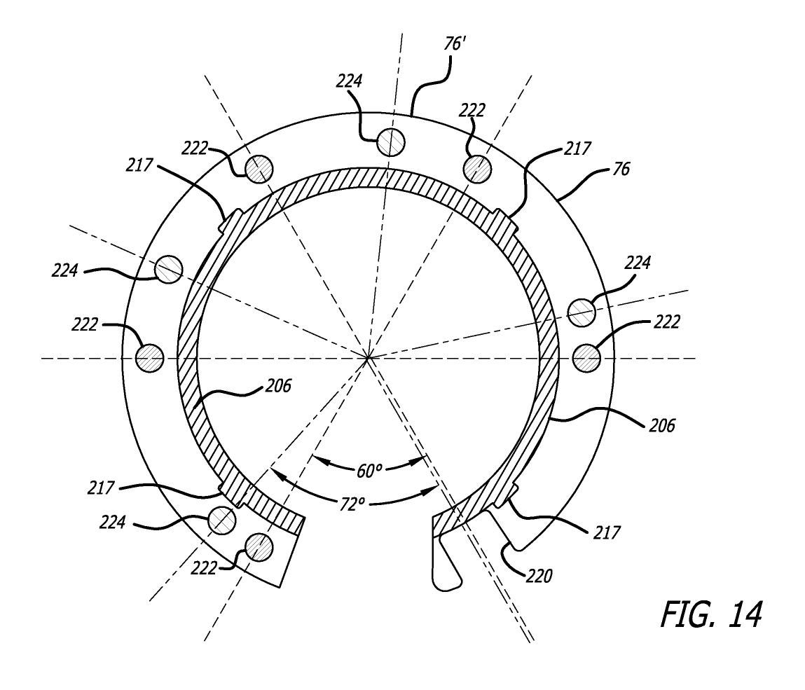

In order to secure the proximal and distal portions to each other to provide a cylindrical portion 202 of variable length, a plurality of threadless holes 212 may be drilled in the upper sleeve 204. The holes 212 are preferably located on a circumferential plane, spaced equally apart from each other, and are preferably four in number, although three may also suffice for adequate support. On the distal portion 210, corresponding threaded holes 214 are provided on a first circumferential plane of the lower sleeve 206 as exemplified in FIG. 12. Additional corresponding threaded holes 216 are provided on a second circumferential plane, and further corresponding holes (not shown) on third, and fourth etc. spaced apart circumferential planes may be provided. Thus, when the installer has determined what the appropriate axial length of the mounting member 200 should be to fit his particular vehicle, he sets the threadless holes 212 on the proximal portion 208 opposite the desired level of threaded holes 214 or 216 etc. on the distal portion 210. He then inserts a threaded screw 218 through the threadless holes 212 and screws the threads into the corresponding threaded hole, repeating for all the holes 212 on the proximal portion until the proximal and distal portion are robustly secured to each other and the length of the mounting member is fixed to the desired length. The spacing of the threaded holes 214 and 216 is preferably 20 mm, which allows the insertion of a thin shim under the flange 76 to take up any small shortfall in the desired length of the mounting member 200 when installing it on an axle. It will be understood that, with equal effect, threadless holes may be provided on a plurality of spaced apart circumferential planes on the proximal portion 208, with only one set of threaded holes on a circumferential plane provided on the distal portion 206, to provide the same capability of varying the axial length of the mounting member 200. In either event, it is preferable that the threaded holes are reinforced by a thicker cylindrical wall, and this may be usefully achieved by welding onto the wall of the cylindrical portion a suitable sized plate 217 (seen in FIGS. 12 and 14), so that threads may be cut into a thicker section of cylindrical wall to provide a more secure connection between proximal and distal portions.

Thus, the variation described allows a stockist to carry the described embodiment for installation on a number of makes of vehicle, rather than having to carry mounting portions of different lengths, each one suitable for only a particular make of vehicle.

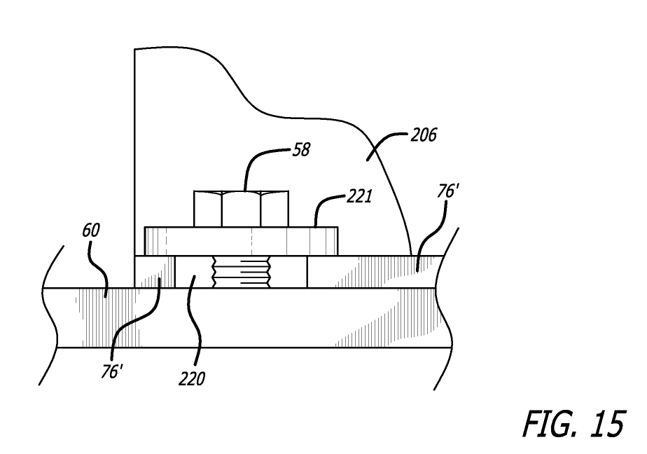

A further variation to the embodiments described in FIGS. 1-10 is now described with reference to FIG. 14-15. As noted above, one of the variations that may be found from one vehicle to another is that some axles may have five hub cap holes 62 and corresponding bolts 58, or it may have six, equally spaced circumferentially. This may give rise to the requirement that a stockist must carry some mounting members with five holes in the flange 76, and some with six holes.

The present invention overcomes this potential requirement. The flange 76′ of the mounting member 200 of the present embodiment is configured to fit onto vehicle axles having either five or six hub cap holes 62. This versatility is achieved by locating a plurality of holes on the flange 76′ as follows. A first common hole 220 is formed in the flange. As may be seen in FIG. 14, the common hole 220 is not bounded by a circular circumference, but has an open shape dictated by considerations that are set forth below. Then, starting from the common hole 220, five more holes 222 are provided in the flange so that each hole 222 including the common hole is spaced equidistant from the other (in effect, these holes are spaced at incremental arcs of 60 degrees around the circumference). Next, starting from the common hole 220, four more holes 224 are provided in the flange so that each hole 224 and the common hole 220 are spaced equidistant from the other (in effect, these holes are spaced at incremental arcs of 72 degrees). This configuration permits the mounting member to be fixed to axles that have either five or six hub cap holes 62, and allows a stockist to carry less stock of mounting members to serve a variety of vehicles.

Turning to the configuration of the common hole 220 in the flange identified above, the following considerations determine its shape. When the hub cap bolts 58 are to be removed so that the mounting member may be bolted on top of the hub cap 54 as described above, a problem may arise in that the hub cap 54, once all the bolts 58 have been removed, may fall off the axle allowing oil or grease to discharge onto the ground, a highly inconvenient result should it occur. The shape of the common hole 220 of the present invention is therefore large enough to permit the installer to remove all but one bolt 58 from the hub cap 54, and to install the flange 76′ over the head of that remaining bolt so that the bolt head fits entirely within the space of the common hole 220. In this way, at least one bolt always holds the hub cap 54 in place and there is no danger of the hub cap falling off the axle at any stage during installation (or, removal) of the mounting member 200. Once the mounting member is installed over the hub cap 54 according to the principles described above, the remaining bolts are inserted to hold both the mounting member and the hub cap in place. Furthermore, the common hole 220 may be made large enough to allow a socket to be inserted through the hole 220 and over a bolt remaining within the hole, so that the bolt may be removed once the balance of the bolts are in place and holding the mounting member and hub in place. Once the remaining bolt is removed, it may be reinserted in the common hole, passing through a short metal plate 221 for transferring the bolt's tension load into the flange 76′ as a holding-down force, as exemplified in FIG. 15, to provide a symmetrically balanced holding-down force around the circumference of the flange 76′. Indeed, it might be feasible to leave one bolt in the common hole 220 without removing it and reinserting it through a plate, but this would introduce an asymmetrical holding-down force on the mounting member 200 which may prove to be undesirable. Thus, the shape of the common hole 220 should preferably be at least large enough to accommodate the head of a hub cap bolt 58 (and not merely the shaft of the bolt), and further preferably large enough to additionally accommodate a socket adapted to fit over the bolt's head so that the bolt may be removed and then reinserted through the plate 221 spanning the hole 220 to apply a holding-down load on the flange 76′.

Thus, using the configuration of the flange 76′ described, in conjunction with the extendable mounting member 200, a stockist my carry less stock than would otherwise be necessary, because the variation allows use of the mounting member in conjunction with an axle having either five hub bolts or a six hub bolts, in addition to being used in conjunction with a wheel having a non-standard axle length. Furthermore, the shape of the common hole 220 provides a procedural advantage in removing and reinserting the bolts 58 for holding down the mounting member 200 on a hub cap 54.

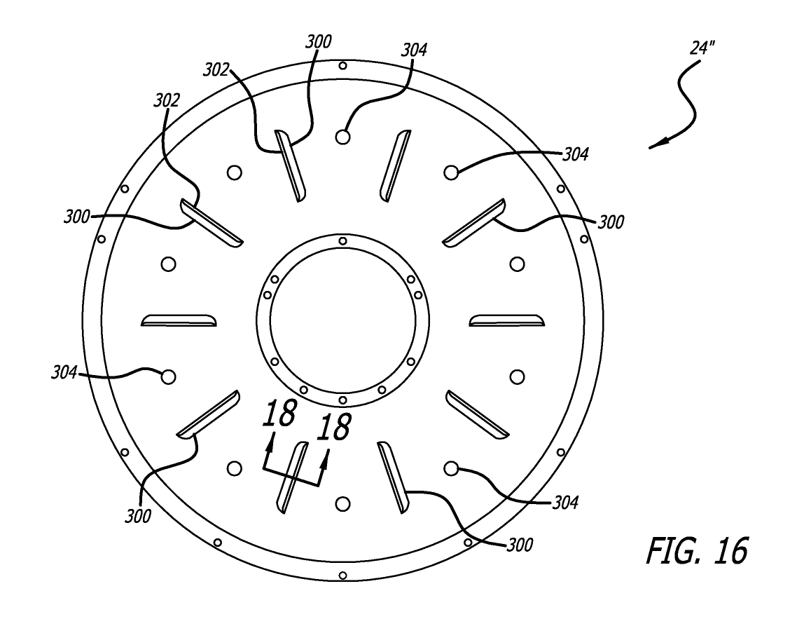

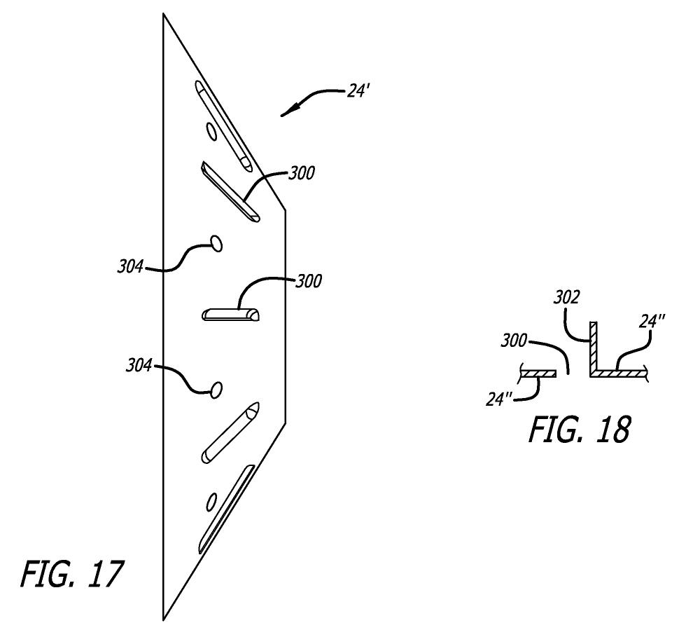

In yet a further aspect of the invention described above, a novel aspect on a foil sheet is described here. The foil sheet of this embodiment is identified generally by the numeral 24″. In this embodiment, the foil sheet 24″ is configured to provide air flow from the exterior of the wheel cover to the space distal to the foil sheet 24″ adjacent to where the brake system is typically housed within the wheel 50. To achieve this objective, a plurality of elongate ventilation holes 300 are punched in the foil sheet 24″ as exemplified in FIG. 16-18. To this end, preferably only three sides of the hole are actually cut in the foil, a fourth side being merely bent, so that a flap 302 of foil is bent outwardly perpendicular to the foil sheet 24″, as exemplified in FIG. 18. Preferably, every alternate hole is cut so that the flap 302 is positioned on an opposite side of the hole than in an adjacent hole, as may be seen in FIG. 16. By this method, when the wheel is in motion, air flow through the region distal to the foil sheet 24″ is enhanced, whereby one flap 302 causes the air to be impelled into the ventilation hole 300 with which it is associated, while the next flap causes the air to be extracted through the ventilation hole with which it is associated, and so on round the circumference of the foil sheet. This causes a rapid flow of air from the outside, through the space distal the foil sheet 24″, and back to the outside again, to provide improved cooling of the area adjacent the wheel braking system.

In another aspect of the preferred embodiment of the foil sheet 24″, between each ventilation hole 300 there is provided a circular hole 304 shaped to receive a valve stem, so that, whatever may be the rotational alignment of the cover assembly as it is attached to the wheel 50, there is a circular hole 304 correctly sized and positioned to receive an air valve stem (not shown) coming from the wheel. The remaining unused valve stem holes 304 also contribute to the air flow from the space distal to the foil sheet.

Thus, it is seen that the covering system of the present invention provides novel and useful features for covering certain kinds of wheel hubs, and overcoming shortcomings in the prior art. The present invention may, of course, be carried out in other specific ways than those herein set forth without departing from the essential characteristics of the invention. The present embodiments are, therefore, to be considered in all respects as illustrative and not restrictive, and all changes coming within the meaning and equivalency range of the appended claims are intended to be embraced therein.

We claim:

1. A wheel covering system for attachment to a vehicle axle, in which the axle has a plurality of threaded lugs for attaching a wheel, and in which a hub cap is attached to the axle by a plurality of threaded bolts, the system comprising:
an ornamental cover having a center point and configured to be positioned adjacent the wheel, the ornamental cover having two holes, each hole offset a given distance from the center point;
a mounting member configured to be removably attached to two diametrically opposite sides of the hub cap without being in contact with the threaded lugs, the mounting member having a distal end and a proximal end, wherein the distal end defines a plurality of holes configured to receive at least some of the threaded bolts for attaching both the mounting member and the hub cap to the axle, and further wherein the proximal end includes two outwardly extending threaded studs for insertion into the two holes so as to removably attach the cover to the mounting member;
wherein, the mounting member has an axis and includes:
a proximal portion and a distal portion, the proximal portion including a first cylindrical portion and the distal portion including a second cylindrical portion, the first cylindrical portion being sized to slide telescopically in relation to the second cylindrical portion, the proximal portion and distal portion having at least one corresponding threaded and unthreaded hole combination for receiving a screw to prevent the proximal portion moving in relation to the distal portion.

2. The wheel covering system of claim 1, wherein one of the proximal portion or the distal portion includes at least two holes spaced axially apart from each other, whereby the proximal portion is capable of being fixed to the distal portion at one of two different axial spacings.

3. The wheel covering system of claim 2, wherein the at least two holes spaced axially apart from each other are two sets of holes, the first set of holes lying on a first circumferential plane, and the second set of holes lying on a second circumferential plane.

4. The wheel covering system of claim 3, wherein each of the first and second sets of holes has four holes in number.

5. The wheel covering system of claim 1, wherein the cover has a third hole at the center point, and the proximal end of the mounting member includes a spindle positioned to be inserted through the third hole.

6. The wheel covering system of claim 5, wherein the third hole includes a conically shaped distal portion to facilitate insertion of the spindle in the third hole.

7. The wheel covering system of claim 5 wherein the spindle is longer than the two threaded studs.

8. A wheel covering system for attachment to a vehicle axle, in which the axle has a plurality of threaded lugs for attaching a wheel, and in which a hub cap is attached to the axle by a plurality of threaded bolts, the system comprising:
an ornamental cover configured to be positioned adjacent the wheel;
a mounting member configured to be removably attached to the hub cap without being in contact with the threaded lugs, the mounting member having a distal end and a proximal end, wherein the distal end defines a plurality of holes configured to receive at least some of the threaded bolts for attaching both the mounting member and the hub cap to the axle, and further wherein the proximal end is configured to attach the ornamental cover to the mounting member;
wherein the plurality of holes defined by the distal end of the mounting member are characterized in that the holes lie on a circumferential plane and include ten holes, the second, fourth, sixth, eight and tenth holes being spaced from the first hole at increments of 60 degree arcs, and the third, fifth, seventh, and ninth holes being spaced from the first hole at increments of 72 degree arcs.

9. The wheel covering system of claim 8, wherein the first hole is shaped to be large enough to receive the head of one of the threaded bolts attaching the hub cap to the axle.

10. The wheel covering system of claim 9, wherein the first hole is shaped to be large enough to receive a socket fitted over the head of the threaded bolt.

11. The wheel covering system of claim 8, wherein the mounting member includes a flange at its distal end, and the holes are formed in the flange.

12. A wheel covering system for attachment to a vehicle axle, in which the axle has a plurality of threaded lugs for attaching a wheel, and in which a hub cap is attached to the axle by a plurality of threaded bolts, the system comprising:
a first cover element configured to be positioned adjacent the wheel;
a second cover element attached to the first cover element along an outer circumferential line by a plurality of screws; and
a mounting member configured to be removably attached to the hub cap without being in contact with the threaded lugs, the mounting member having a distal end and a proximal end, wherein the distal end defines a plurality of holes configured to receive at least some of the threaded bolts for attaching both the mounting member and the hub cap to the axle, and further wherein the proximal end is configured to attach the first cover element to the mounting member;
wherein the second cover element includes:
a plurality of elongate openings; and
a rigid flap positioned adjacent each opening, wherein each flap extends outwardly from a surface of the second cover element, and each alternate flap is positioned on a circumferentially opposite side of an opening compared with the position of each adjacent flap.

13. The wheel covering system of claim 12, wherein the second cover element further includes a circular hole between each elongate opening, the circular hole being sized to receive a valve stem from the wheel.

14. The wheel covering system of claim 12, wherein the second cover element is attached to the first element along a second, inner circumferential line by a plurality of screws.

15. The wheel covering system of claim 12, wherein the second cover element includes a proximal surface treated to provide a polished surface for reflecting light.
